(19) United States
(12) Patent Application Publication
(10) Pub. No.: US 2004/0183993 A1
(43) Pub. Date: Sep. 23, 2004

(54) Temple bar clasp for eyeglasses

(76) Inventor: Dan L. Dietz, Houston, TX (US)

Correspondence Address: CONLEY ROSE, P.C., P. O. BOX 3267, HOUSTON, TX, 77253-3267, US

(21) Appl. No.: 10/391,429

(22) Filed: Mar. 18, 2003

(51) Int. Cl. G02C 1/00

(52) U.S. Cl. 351/41

(57) ABSTRACT

An eyeglasses temple bar clasp for maintaining eyeglasses on a material such as clothing. Clasp comprises temple bars comprising magnetic material such that the temple bars magnetically attract each other through the material when the temple bars are closed. The clasp is used by pivoting one of the temple bars into the closed position. The frame body and closed temple bar are then positioned on one side of the material. The second temple bar is then pivoted into the closed position such that it is on the other side of the material. With the temple bars closed, the temple bars impart a gripping force on the material, thus clasping the eyeglasses to the material.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to improved eyeglasses. More particularly, it relates to an eyeglasses temple bar clasp for maintaining the eyeglasses in a pocket or on another portion of a clothing material when the eyeglasses are not in use.

2. Description of the Related Art

Typical eyeglasses consist of a frame body that houses two lenses on either side of a nosepiece. Attached to the frame body are two temple bars that extend from two ends of the frame body. The temple bars pivot between an open position perpendicular with the frame body and a closed position parallel with the frame body. The temple bars and nosepiece support the frame on the head of the wearer.

Individuals often remove their eyeglasses temporarily. They may put them down and not recall where, they may hang them around their neck where they bounce against their chest, or they may put them in a pocket and have them fall out and/or get damaged.

To solve this problem, mechanical clips attach eyeglasses to a garment worn by the user. Mechanical clips, however, are cumbersome and, like all mechanical clips, may come loose. Some mechanical clips also depend on the availability of a shirt pocket, a cap visor, belt, holder, straps, or the like. In addition, clips may work well initially, but fatigue can cause metal clips to weaken and lose their ability to hold eyeglasses securely. Moreover, clips can break, thereby causing the eyeglasses to come loose, fall and break, or be lost. U.S. Pat. No. 6,017,120 to McCormick teaches a mechanical clip attached to the hinged end of the temple bars. Eyeglasses using such mechanical clips may not be securely held in place when inverted, such as when a person bends over at the waist. Another problem with such clips arises when a person in a sitting position bends forward, pushing the eyeglasses upward while clipped inside a shirt pocket. In that situation, the clip may be pushed up from the bottom of the pocket, thereby disengaging the clip and causing the eyeglasses to fall from the pocket.

The use of magnets on eyeglass frames for various purposes is also well known in the art. For example, a number of eyeglass frames have magnets that magnetize the wearer for health benefits. Other eyeglass frames use magnets to hold eyeglass frame sections together, thereby facilitating disassembly and reassembly in a new configuration, with auxiliary frames, lenses, or the like. U.S. Pat. No. 6,168,273 B11 to Dupraz et al. teaches the use of magnets on eyeglass frames to temporarily affix the eyeglasses on a support article having magnetic means. Because the magnets in Dupraz et al. are attached to the temple bar near the hinges, however, its teaching cannot be used as a magnetic clasp, nor was it intended as such.

### SUMMARY OF THE EMBODIMENTS

An eyeglasses temple bar clasp comprises eyeglasses with two temple bars comprising magnetic material. The magnetized temple bars are in attractive magnetic communication at least when the temple bars are in the closed position. A wearer typically uses the clasp by pivoting one of the temple bars into the closed position. The frame body and closed temple bar are then positioned on one side of a clothing material, such as, by way non-limiting example only, a shirt pocket or sleeve. The second temple bar is then pivoted into the closed position such that it is on the other side of the clothing material. The temple bars are then in attractive magnetic communication and impart a gripping force on the clothing material. The magnetic temple bars thereby eliminate the disadvantages of a mechanical clip while introducing the advantage of a strong, versatile clasp that can be easily opened and closed anywhere the magnets are capable of being in strong enough attractive magnetic communication through the clothing material.

The embodiments of the eyeglasses temple bar clasp may be in the form of complete eyeglasses or simply the temple bars themselves that are suitable for attachment to an eyeglasses frame.

Thus, the embodiments comprise a combination of features and advantages that enable it to overcome various problems of prior devices. The various characteristics described above, as well as other features, will be readily apparent to those skilled in the art upon reading the following detailed description of the embodiments, and by referring to the accompanying drawings.

### BRIEF DESCRIPTION OF THE DRAWINGS

For a more detailed description of the embodiments, reference will now be made to the following accompanying drawings:

FIG. 1A is a bottom view of eyeglasses incorporating an eyeglasses clasp with temple bars pivoted in the open position as when the eyeglasses are worn;

FIG. 1B is a perspective view of the eyeglasses incorporating an eyeglasses clasp with one of the temple bars pivoted into the closed position;

FIG. 1C is a side view of the eyeglasses incorporating an eyeglasses clasp with one of the temple bars pivoted into the closed position;

FIG. 1D is a bottom view of the eyeglasses incorporating an eyeglasses clasp with the temple bars pivoted into the closed position;

FIG. 2 is a bottom view of the eyeglasses incorporating the eyeglasses clasp with the temple bars pivoted in the closed position;

FIG. 3A is a bottom view of eyeglasses incorporating another embodiment of an eyeglasses clasp with temple bars pivoted in the open position as when the eyeglasses are worn; and

FIG. 3B is a perspective view of the eyeglasses incorporating another embodiment of an eyeglasses clasp with one of the temple bars pivoted into the closed position.

### DETAILED DESCRIPTION OF THE EMBODIMENTS

The present invention relates to an eyeglasses clasp and is susceptible to embodiments of different forms. The drawings and the description below disclose in detail specific embodiments of the present invention with the understanding that this disclosure is to be considered an exemplification of the principles of the invention, and is not intended to limit the invention to that illustrated and described in the disclosure. Further, it is to be fully recognized that the different teachings of the embodiments discussed below may be employed separately or in any suitable combination to produce desired results.

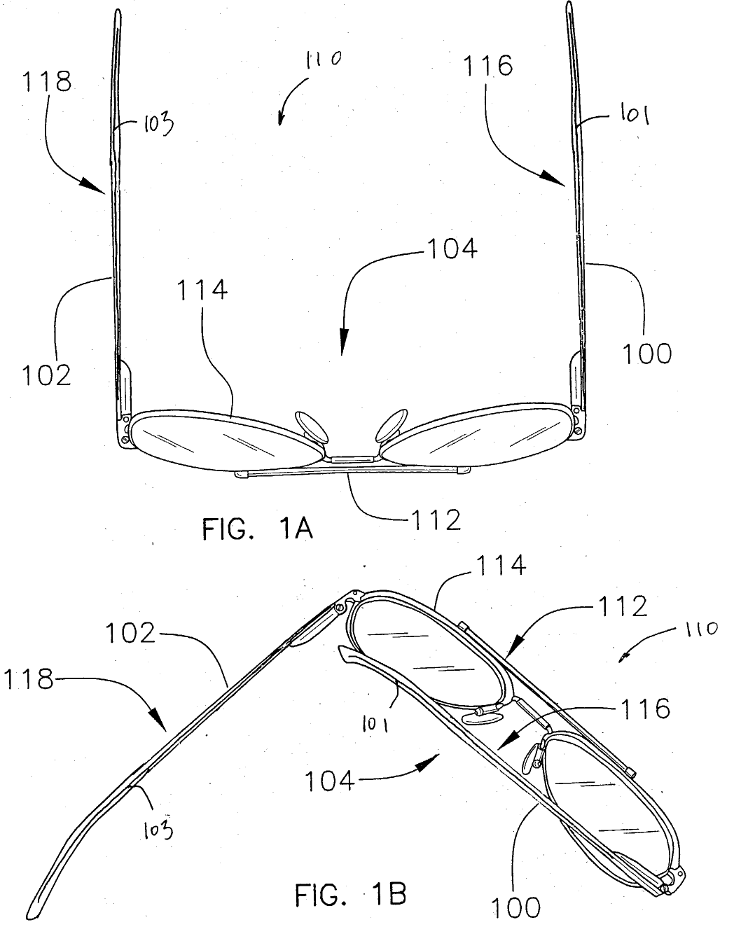

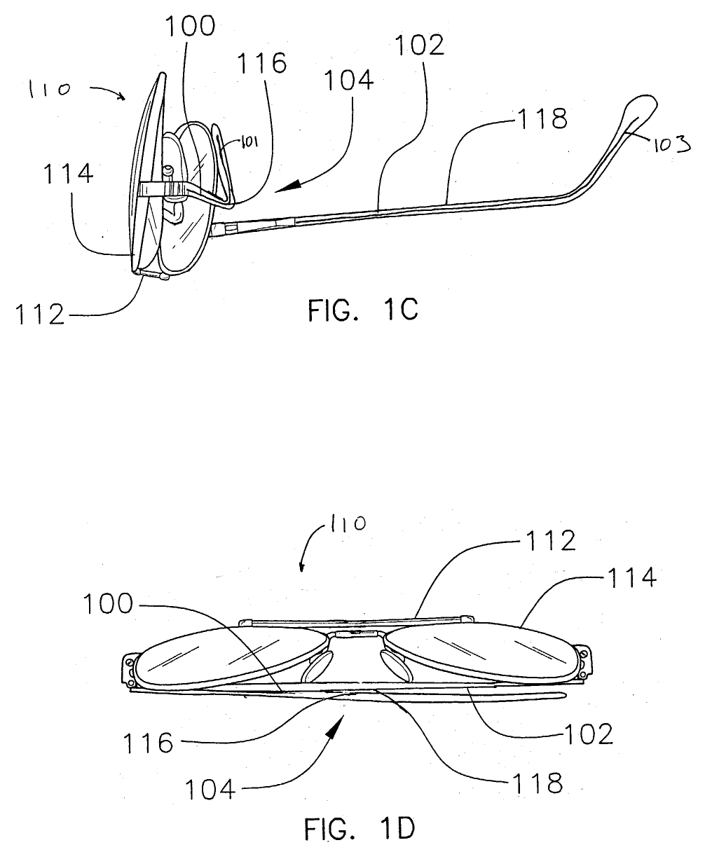

FIGS. 1A-1D show an embodiment of the temple bar eyeglasses clasp 104. Eyeglasses 110 comprise a first temple bar 100 and a second temple bar 102 pivotally attached to an eyeglasses frame body 114 by any suitable means. Typically, spring action hinges, well known in the art, pivotally attach the temple bars 102, 103. The temple bars 100, 102 pivot between an open position perpendicular to the eyeglasses frame body 114 and a closed position parallel to the frame body 114. When in the open position, the temple bars form a squared “U” shape as illustrated in FIG. 1A. The frame body 114 also includes a nosepiece 112.

The first and second temple bars 100, 102 comprise magnetic material. The first and second temple bars 100, 102 comprise a wire of magnetic material 101, 103 within the first and second temple bars 100, 102 themselves, respectively. The wire 101, 103 may extend the length of the temple bars 100, 102, or may only extend through a portion of the temple bars 100, 102. Alternatively, the temple bars 100, 102 themselves may comprise magnetic material or any other suitable configuration of magnetic material. The magnetic material may be any suitable material. For example, the magnetic material may be a rare earth metal, such as Neodymium.

The first and second temple bars 100, 102 are such that the polarity of the magnetic material directed outside the “U” in FIG. 1A is the same. Thus, as illustrated in FIG. 1D, when the first and second temple bars 100, 102 are pivoted closed, the first and second temple bars 100, 102 are in attractive magnetic communication created by the opposite poles of the magnetic material. FIG. 1D shows second temple bar 102 folded on the inside of the first temple bar 100. The South pole side 116 of the first temple bar 100 magnetic material thus faces and aligns with the North pole side 118 of the second temple bar 102 magnetic material, thereby holding the temple bars 100, 102 securely in the closed position.

The eyeglasses clasp 104 is not limited to a complete set of eyeglasses. The eyeglasses clasp 104 may also comprise the temple bars 100, 102 by themselves that are suitable for attachment to the eyeglasses frame 114.

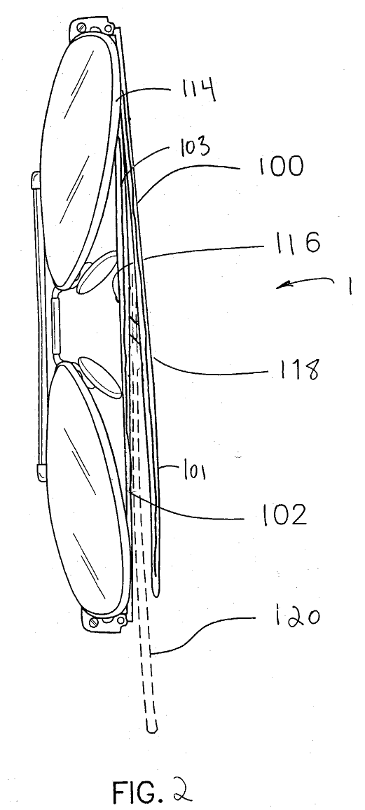

FIG. 2 shows how the clasp 104 may be used to clasp the eyeglasses 110 to an article of clothing 120. The clasp 104 may also be used to clasp the eyeglasses to any article through which the magnetic attraction of the temple bars 100, 102 is strong enough for the temple bars 100, 102 to attract each other. In FIG. 2, the first temple bar 100 and the second temple bar 102 of the eyeglasses clasp 104 are pivoted into the closed position. The first temple bar 100 is positioned outside a clothing material 120. The second temple bar 102 is positioned inside the clothing material 120. Thus, the clothing material 120 is located between the temple bars 100, 102. During use, the wearer pivots one of the temple bars 100, 102 into the closed position. The wearer then positions the eyeglasses frame body 114 and the closed temple bar 100, 102 on one side of the clothing material 120. The wearer then pivots the other temple bar 100, 102 into the closed position such that it is on the other side of the clothing material 120. The South pole side 116 of the first temple bar 100 faces the North pole side 118 of the second temple bar 102. Although on either side of the clothing material 120, the temple bars 100, 102 are in attractive magnetic communication with each other. The magnetic attraction is strong enough to impart a gripping force on the clothing material 120; thereby clasping the eyeglasses 114 securely clasped to clothing material 120. The gripping force substantially prevents relative movement between the eyeglasses 114 and the clothing material 120 while the temple bars 100, 102 are in the closed position. The magnetic attraction is even strong enough to keep the eyeglasses 114 in place even when jarred. The magnetic attraction also maintains its strength because the magnetic flux is not diminished by repeated use. It should be appreciated that either temple bar 100, 102 may be pivoted into the closed position before the other and still be within the scope of the invention. The clasp 104 may also operate on any portion of the wearer's garments where the magnetic attraction is strong enough through the garment. For example, the clasp 104 may be used on a pocket, lapel, neck collar, or the like.

The clasp 104 eliminates difficulties associated with using a support article by, in effect, using the eyeglasses 110 themselves as a means for clasping onto any material through which the attractive magnetic communication may be maintained. For example, a separate support article incorporated in clothing would be cumbersome in washers and dryers, difficult to iron, and alter the appearance of the garment whereas the clasp 104 has none of these disadvantages. In addition, unlike mechanical clips that attach to clothing described in the prior art, the clasp 104 is not limited by the requirement that such clips attach to the edge of material. Instead, the clasp 104 attaches anywhere through material so that only a hinged edge of the frame body 114 is at the edge of the material 120. Thus, for example, the present invention permits the eyeglasses 110 to be clasped more deeply in a pocket, whereas prior art clips require a greater portion of the eyeglasses to protrude outside the pocket. Moreover, the eyeglasses 110 stay attached regardless of the position in which the clothing material edge is placed.

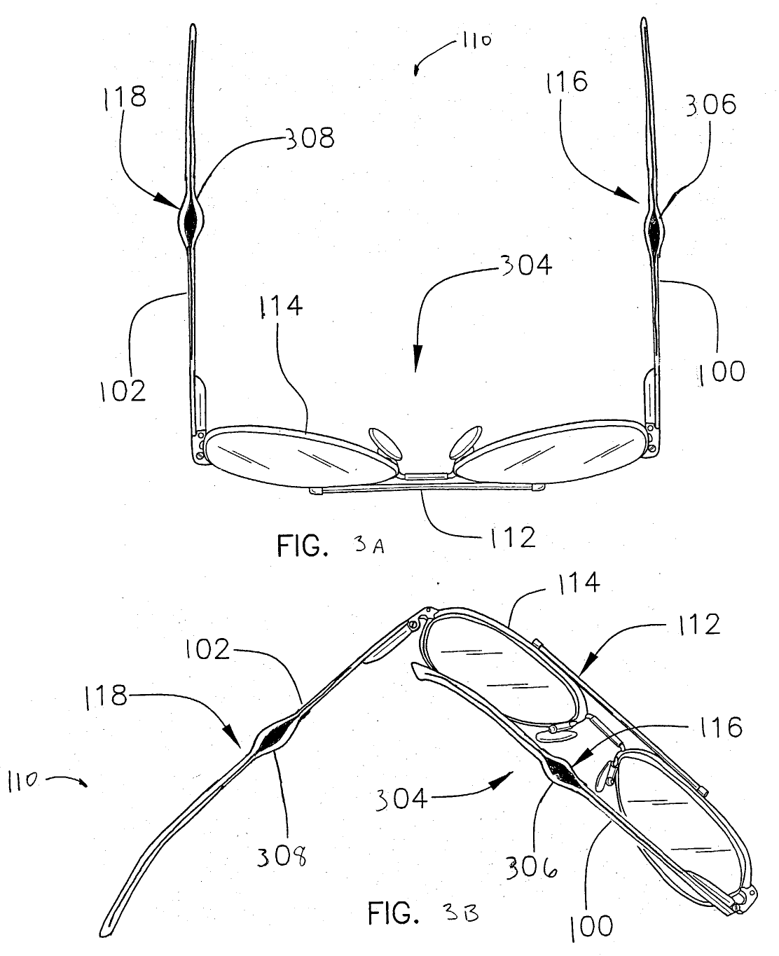

FIGS. 3A and 3B show an alternative eyeglasses temple bar clasp 304. Temple bar clasp 304 includes the same features and operates in the same manner as clasp 104. In clasp 304, however, the temple bars 100, 103 additionally comprise “bulges” 306, 308. The bulges 306, 308 are increased areas of magnetic material. FIGS. 3A and 3B show the bulges 306, 308 at approximately the midpoints of the temple bars 100, 102. However, the bulges 306, 308 may be located at any location along the temple bars 100, 102. There may also be multiple bulges 306, 308 on each temple bar 100, 102. In addition, the bulges 306, 308 may be of any size and configuration. For example, the bulges 306, 308 may be magnets that are inserted in the temple bars 100, 102 in addition to the magnetic material in clasp 104 shown in FIGS. 1A-1D.

The increased mass of the bulges 306, 308 provides additional magnetic attraction between the temple bars 100, 102. The increased magnetic attraction of bulges 306, 308 allows the clasp 304 to provide additional gripping power. In addition, the bulges 306, 308 allow the wearer to use the clasp 304 on material that requires the additional magnetic attraction of the bulges 306, 308 to maintain the magnetic attraction between the temple bars 100, 102 in the closed position.

While specific embodiments have been shown and described, modifications can be made by one skilled in the art without departing from the spirit or teaching of this invention. The embodiments as described are exemplary only and are not limiting. Many variations and modifications of the system and apparatus are possible and are within the scope of the invention. Accordingly, the scope of protection is not limited to the embodiments described, but is only limited by the claims that follow, the scope of which shall include all equivalents of the subject matter of the claims.

What is claimed is:

1. Eyeglasses comprising:
a frame body, a first temple bar pivotally engaged to the frame body, and a second temple bar pivotally engaged to the frame body;
the first temple bar comprising magnetic material;
the second temple bar comprising magnetic material; and
where the first temple bar magnetically attracts the second temple bar at least when the temple bars are in a closed position but separated by a material such that the first and second temple bars impart a gripping force on the material.

2. The eyeglasses of claim 1 where the magnetic material is a wire inside the first and second temple bars.

3. The eyeglasses of claim 1 where the magnetic material is inside the first and second temple bars.

4. The eyeglasses of claim 3 where the first magnetic material is included in the entire length of the first temple bar and the second magnetic material is included in the entire length of the second temple bar.

5. The eyeglasses of claim 3 where the first temple bar magnetic material is only included in a portion of the length of the first temple bar and the second temple bar magnetic material is only included in a portion of the length of the second temple bar.

6. The eyeglasses of claim 1 where the first and second temple bars are magnetic material.

7. The eyeglasses of claim 1 where the first and second temple bar magnetic materials are non-uniform in shape along the length of the magnetic materials.

8. The eyeglasses of claim 7 where the first and second temple bar magnetic materials comprise at least one area of increased mass.

9. The eyeglasses of claim 8 where each first temple bar magnetic material area of increased mass aligns with a corresponding second temple bar magnetic material area of increased mass such that the corresponding areas of increased magnetic material mass magnetically attract each other at least when the first and second temple bars are in the closed position.

10. The eyeglasses of claim 1 where the first and second temple bar magnetic material is a rare earth metal.

11. The eyeglasses of claim 10 where the rare earth metal is Neodymium.

12. Eyeglasses comprising:
a frame body, a first temple bar pivotally engaged to the frame body, and a second temple bar pivotally engaged to the frame body;
the first temple bar comprising a first magnetic wire enclosed within the first temple bar;
the second temple bar comprising a second magnetic wire enclosed within the second temple bar; and
where the first temple bar magnetically attracts the second temple bar when the temple bars are in a closed position but separated by a material such that the first and second temple bars impart a gripping force on the material.

13. The eyeglasses of claim 12 where the first and second magnetic wires are included in the entire lengths of the first and second temple bars.

14. The eyeglasses of claim 12 where the first and second magnetic wires are only included in a portion of the lengths of the first and second temple bars.

15. The eyeglasses of claim 12 where the first and second magnetic wires are non-uniform in shape along the length of the first and second magnetic wires.

16. The eyeglasses of claim 15 where the first and second magnetic wires comprise at least one area of increased mass.

17. The eyeglasses of claim 16 where each first magnetic wire area of increased mass aligns with a corresponding second magnetic wire area of increased mass such that the corresponding areas of increased mass magnetically attract each other at least when the first and second temple bars are in the closed position.

18. The eyeglasses of claim 12 where the first and second magnetic wires are a rare earth metal.

19. The eyeglasses of claim 18 where the rare earth metal is Neodymium.

20. A clasp for eyeglasses comprising:
a first temple bar comprising magnetic material;
a second temple bar comprising magnetic material; and
where the first temple bar magnetically attracts the second temple bar at least when the temple bars are attached to eyeglasses and are in a closed position but separated by a material such that the first and second temple bars impart a gripping force on the material.

21. The clasp of claim 20 where the magnetic material is a wire inside the first and second temple bars.

22. The clasp of claim 20 where the magnetic material is inside the first and second temple bars.

23. The clasp of claim 22 where the first magnetic material is included in the entire length of the first temple bar and the second magnetic material is included in the entire length of the second temple bar.

24. The clasp of claim 22 where the first temple bar magnetic material is only included in a portion of the length of the first temple bar and the second temple bar magnetic material is only included in a portion of the length of the second temple bar.

25. The clasp of claim 20 where the first and second temple bars are magnetic material.

26. The clasp of claim 20 where the first and second temple bar magnetic materials are non-uniform in shape along the length of the magnetic materials.

27. The clasp of claim 26 where the first and second temple bar magnetic materials comprise at least one area of increased mass.

28. The clasp of claim 27 where each first temple bar magnetic material area of increased mass aligns with a corresponding second temple bar magnetic material area of increased mass such that the corresponding areas of increased magnetic material mass magnetically attract each other at least when the first and second temple bars are in the closed position.

29. The clasp of claim 20 where the first and second temple bar magnetic material is a rare earth metal.

30. The clasp of claim 29 where the rare earth metal is Neodymium.

31. A method of engaging eyeglasses comprising a frame, a first temple bar, and a second temple bar to a material comprising:
pivoting the first temple bar to a closed position, the first temple bar comprising magnetic material;
positioning the frame and first temple bar on one side of the material;
pivoting the second temple bar to a closed position such that the second temple bar is on the other side of the clothing material than the frame body and first temple bar, the second temple bar comprising magnetic material; and
magnetically attracting the second temple bar with the first temple bar to impart a gripping force on the material.

32. The method of claim 31 where the first temple bar magnetic material comprises a first magnetic wire and the second temple bar magnetic material comprises a second magnetic wire.
